(19) United States
(12) Patent Application Publication
(10) Pub. No.: US 2008/0300861 A1
(43) Pub. Date: Dec. 4, 2008

(54) WORD FORMATION METHOD AND SYSTEM

(76) Inventors: Ossama Emam, Giza (EG); Walid Mohamed Magdy, Giza (EG)

Correspondence Address: IBM CORP (YA);C/O YEE & ASSOCIATES PC, P.O. BOX 802333, DALLAS, TX, 75380, US

(21) Appl. No.: 12/026,319

(22) Filed: Feb. 5, 2008

(30) Foreign Application Priority Data
Jun. 4, 2007 (FR) 07109483.3

(51) Int. Cl. G06F 17/20

(52) U.S. Cl. 704/8

(57) ABSTRACT

A computer-implemented method of word formation in a data processing system. A plurality of basic Arabic naked characters is received in sequence. The plurality of basic Arabic naked characters is concatenated to form a naked word including the plurality of basic Arabic naked characters. The naked word is associated with a first Arabic-like language. The naked word is transformed into a complete word in the first Arabic-like language. The complete word is displayed.

### BACKGROUND OF THE INVENTION

1. Field of the Invention

The present application relates to data entry using the Arabic alphabet, and in particular to the formation of words from such data entry. In the present application, the term Arabic alphabet is used in a broad sense to include not only characters and symbols used in Arabic language, but also those used in other Arabic-like languages such as Persian, Urdu, Malay, Azerbaijani, Kurdish, Farsi, Dari, Pashto, Azeri, Kashmiri, Sindhi, Hausa, and others.

2. Description of the Related Art

A keyboard is a set of typewriter-like keys that enable users to enter data into a computer. Computer keyboards are similar to electric-typewriter keyboards, but contain additional keys. The keys on computer keyboards are often classified as follows:

alphanumeric keys—letters and numbers

punctuation keys—comma, period, semicolon, and so on.

special keys—function keys, control keys, arrow keys, Caps Lock key, and so on.

The standard layout of letters, numbers, and punctuation is known as a QWERTY keyboard because the first six keys on the top row of letters spell QWERTY. This keyboard dominates in cultures using the Latin alphabet (with exception of the French culture where the AZERTY keyboard is used). The keyboard layout also includes several layers: Normal, Shift, Ctrl, Ctrl+Shift, Ctrl+Alt, Ctrl+Shift+Alt, and “Shift Lock,” so it is possible to define just about any key combination for special characters. However, there is always a need to reduce the number of keys that are used to input a language character set, i.e. in order to provide a smaller keyboard and/or a keyboard with a minimum number of layers. Additionally, none of the prior art teaches a satisfactory means of data entry using the Arabic alphabet in a broad sense. Thus, a better solution to data entry using the Arabic alphabet is desirable.

### SUMMARY OF THE INVENTION

The illustrative embodiments provide for a computer-implemented method, computer program product, and data processing system for word formation in a data processing system. A plurality of basic Arabic naked characters is received in sequence. The plurality of basic Arabic naked characters is concatenated to form a naked word the plurality of basic Arabic naked characters. The naked word is associated with a first Arabic-like language. The naked word is transformed into a complete word in the first Arabic-like language. The complete word is displayed.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 is a table of the mapping between the original characters of different languages and its Basic Arabic Naked Character (BANC), in accordance with an illustrative embodiment;

FIG. 2 shows a text entry device suitable to receive input, in accordance with an illustrative embodiment;

FIG. 3 is a block diagram detailing internal circuitry of the device of FIG. 2, in accordance with an illustrative embodiment;

FIG. 4 is a flow diagram illustrating operation of the device of FIG. 2 in the automatic entry mode, in accordance with an illustrative embodiment;

FIG. 5 is a flow diagram illustrating further details of the operation of the process shown in FIG. 4, in accordance with an illustrative embodiment;

FIG. 6 is a flow diagram illustrating further details of the operation of the process shown in FIG. 4, in accordance with an illustrative embodiment;

FIG. 7 is a flow diagram illustrating further details of the operation of the process shown in FIG. 4, in accordance with an illustrative embodiment;

FIG. 8 is an illustrative example showing how dots and marks are automatically added when using the automatic entry mode, in accordance with an illustrative embodiment;

FIG. 9 is a flow diagram illustrating operation of the device of FIG. 2 in the manual entry mode, in accordance with an illustrative embodiment; and

FIG. 10 is an illustrative example of manual entry mode, in accordance with an illustrative embodiment.

### DETAILED DESCRIPTION OF THE PREFERRED EMBODIMENT

The present invention provides a reduced character keys for the Arabic-like languages. Word-level and context-level disambiguation may be used to resolve ambiguities in keystrokes. In one embodiment, the system is implemented as a keypad of a cellular phone. Alternatively, the system can be constructed for any limited keys device, and it can be implemented for limited layers keyboards.

Each keystroke sequence is processed with a complete database containing the spelling of a huge lexicon of words. The database is large enough that it contains virtually all of the words that a user might enter, including proper names and geographical terms (cities, countries, etc.). Any words not included (such as the user's last name) are automatically added to the database when first typed by the user using an alternate unambiguous spelling method.

Words that match the sequence of keystrokes are presented to the user in a list on the display. The words are presented in order of decreasing frequency of use so that the most frequently occurring word is presented first in the list. After typing a word, the user simply activates the “Space” key, or perhaps more accurately the “Select” key. Activating the appropriate key automatically selects the first word, which can be the most frequently used word, and enters a space. The user then begins typing the next word. Occasionally, approximately once in thirty to forty words, the desired word will be the second or third most frequently used word matching the key sequence entered. In such cases, the user presses the “Select” key one or two more times to select the desired word before beginning to type the next word. On a touch screen application, the user may also directly touch the desired word to select it. Thus, for the vast majority of text entered, the user simply types, hitting the keys containing the desired letters, one keystroke per character, and hits the “Select” key at the end of each word just as one would type a space on a standard “QWERTY” keyboard.

All prior work and current state of the art are directed towards the reduction of keys while keeping the original set of characters of the language, and hence trying to solve the textual entry keystrokes ambiguity problem as a number of keys containing multiple characters. In many of the Arabic-like languages, the number of characters is very high. An example language is Pashto, which has an alphabet of 52 different characters.

1. Need for a Small Keyboard by Reducing the Number of Keys:

Technological advances have increased the desire to carry smaller and smaller personal communicating devices, such as pagers, cellular phones, and other personal communicator devices, with optimum functionality. Additionally, automation of homes through combinations of telecommunications and cable has increased the desire to carry small devices, such as those devices that operate a variety of appliances or control a variety of applications in smart rooms. Thus, the need and desire to enter alphanumeric text through non-alpha or numeric keypad is ever increasing.

It would therefore be advantageous to develop a keyboard for entry of text into a computer device that is both small and operable with one hand while the user is holding the device with the other hand.

2. Need to Reduce the Number of Layers of the Keyboard:

There are cases where a minimum number of layers of keyboard should be used. For instance, the projection keyboard is a new application that resolves a missing link with mobile and wireless communication devices. Current input solutions, such as keypads, thumb keyboards, or handwriting recognition, though popular, are limited in their ability to support typing-intensive applications. Typing-intensive applications include document and memo creation, as well as email composition. Celluon, for example, produces such an application.

When equipped with a projection keyboard, the smart phones, cell phones, PDAs, or other mobile or wireless devices use a tiny laser pattern projector to project the image of a full-sized keyboard onto a convenient flat surface between the device and the user. The user can then type on this image and Canesta's electronic perception technology will instantly resolve the user's finger movements into ordinary serial keystroke data that is easily utilized by the wireless or mobile device. The recognition process works as follows: When the user presses a key on the projected keyboard, the infrared layer is interrupted. This produces UV reflections that are recognized by the sensor in three dimensions, allowing the system to assign a coordinate to a keyboard character.

In summary, it is desirable to reduce the number of keys that are used to input a language character set. However, this task is not trivial, and is even more problematic for languages that have a high number of characters. For example, the Arabic alphabet has a high number of characters. A number of other languages are based on Arabic (referred-to as “Arabic-like” languages), such as Arabic, Azerbaijani, Hausa, Kashmiri, Kurdish, Malay, Persian (Farsi), Pashto, Sindhi, Turkish, Urdu, and Uyghur, which vary in the number of characters representing each alphabet. The number of characters for these languages ranges from twenty-six to fifty-four characters according to the language, but all have the same basic shape of the characters and differ only in the number and place of dots and other marks (hamza, dash, circle, etc) around the characters.

All prior work and current state of the art in this area relate generally to reduced keyboard systems and more specifically to reduced keyboard systems using disambiguation to resolve ambiguous keystrokes. The original set of characters of the language is kept the same.

Prior development work has considered use of a keyboard that has a reduced number of keys. As suggested by the keypad layout of a touch-tone telephone, many of the reduced keyboards have used a 3-by-4 array of keys. The keyboard has twelve keys, nine of them labeled with numerous letters and other symbols, and those nine plus one more are labeled each with one of the ten digits.

in case of English language (26 characters): 6 keys×3 characters+2 keys×4 characters

in case of Arabic language (28 characters): 1 key×2 characters (several variants)+1 key×3 characters+5 keys×4 characters+1 key×5 characters.

Other reduced keyboards have used a 5-by-4 array of keys to represent the QWERTY keyboard. −in case of English language (26 characters): 12 keys×2 characters+2 keys×1 characters.

In the above mentioned keypad, textual entry keystrokes are ambiguous, since each key has several characters. However, this ambiguity can be resolved manually by the user, or automatically by the communication device itself. Manual resolution requires the user to enter two or more keystrokes to specify each letter. Automatic resolution is based on research on automatic disambiguation of text input. Automatic resolution, to date, has focused on two strategies, letter-by-letter (character-level) disambiguation and word-level disambiguation.

In the letter-by-letter approach, the system tries to disambiguate each key as it is selected. Statistical analysis of “n-grams” (groups of n letters as they occur in sequence in words) is usually the predictive basis for these systems. One advantage of this approach is that the number of n-grams is relatively small, so storage/memory requirements are also small. A disadvantage of letter-by-letter disambiguation is that the user's attention is required as each key is selected.

In word-level disambiguation, user input is interpreted as complete words. The predictive basis for a word-level system is a database of words. To be effective, this approach requires that all possible words be present in the database; so storage requirements are larger than for the letter-by-letter approach

Tegic Communications (“Tegic”) has developed a technique for text input commercially known as T9(TM), which enables generation of any desired text using a reduced keyboard having only a small number of keys. This system is based on “word-level disambiguation,” where the system compares a sequence of keystrokes to words in a large database to determine the intended word. The T9 technology includes improvements over previous attempts to implement disambiguation approaches. The trademark T9 stands for “typing with 9 keys.”

In an example prior art, a dictionary is searched for candidate combinations of characters corresponding to the keys activated. In another prior art, a set of characters associated with the first character key is displayed. A second set of characters is associated with the second character key. A character from the first set of characters is combined with a character from the second set of characters. A set of alternative n-grams are displayed, derived from the step of combining, in descending order based on a probability of frequency of use in a given language.

In another prior art, the disambiguating system includes a vocabulary module that contains a library of objects that are each associated with a keystroke sequence. Each object is also associated with a frequency of use. Objects within the vocabulary modules that match the entered keystroke sequence are identified by the disambiguating system. Objects associated with a keystroke sequence that match the entered keystroke sequence are displayed to the user in a selection list.

In yet another prior art, a reduced keyboard disambiguating system for the Korean language uses word-level disambiguation to resolve ambiguities in keystrokes. A plurality of letters is assigned to each of a plurality of data keys, so that keystrokes on these keys are ambiguous. A user may enter a keystroke sequence wherein each keystroke corresponds to the entry of one letter of a word. Because individual keystrokes are ambiguous, the keystroke sequence can potentially match more than one word with the same number of letters. The keystroke sequence is processed by matching the input keystroke sequence to corresponding stored words or other interpretations.

In yet another prior art, the user strikes a delimiting “select” key at the end of each word, delimiting a keystroke sequence which could match any of many words with the same number of letters. The keystroke sequence is processed with a complete dictionary, and words which match the sequence of keystrokes are presented to the user in order of decreasing frequency of use. The user selects the desired word. The letters are assigned to the keys in a non-sequential order, which reduces chances of ambiguities. The same “select” key is pressed to select the desired word, and spacing between words and punctuation is automatically computed. For words which are not in the dictionary, two keystrokes are entered to specify each letter. The system simultaneously interprets all keystroke sequences as both one stroke per letter and as two strokes per letter. The user selects the desired interpretation. The system also presents to the user the number which is represented by the sequence of keystrokes for possible selection by the user.

Another prior art relates to text input technology. The publication discloses an apparatus comprising a display device, and a reduced keyboard which enables a user to enter text. Each key on the reduced keyboard represents a set of characters. When a key is pressed by a user, the display device shows a list of characters represented by the key to the user. The user may then select an intended character from the list. Further, when a user presses a sequence of keys, a list of probable words corresponding to the sequence of keys is displayed to the user.

One prior art relates to manual input of data and discloses a method and apparatus for assigning a relatively large set of characters to a small keyboard. The characters may be alphabets of any language, including the Arabic language. The system consists of a 12 key keyboard, with each key representing a basic stroke. The basic strokes may be combined to produce any character of a language. The sequence of strokes for creating a character follows the order in which those strokes are produced when the character is written by hand.

Another prior art describes a scheme for stylus-based input of phonetic scripts, such as Indic, using a compact smart soft-keyboard. Phonetically related characters are grouped into layers and become dynamically available when the “group-leader” character is accessed. This scheme allows rapid input using taps and flicks. This scheme is proposed for compact keyboarding of phonetic scripts, such as Indic, on hand-held and mobile devices. This scheme can be extended to other phonetic scripts such as IPA. This scheme can also be used equally well as an alternate, simpler soft keyboard for conventional desktop systems.

Another prior art discusses how diacritics—marks above, through, or below letters—are used in orthography to remedy the shortcomings of the ordinary Latin alphabet. This prior art catalogues the various diacritics that are in use for spelling different languages, describing what they look like and what they are used for. It also analyses the problems of using accented letters in a multilingual computing environment, and discusses the extent to which these problems have been resolved, with particular reference to Unicode.

However, several drawbacks of using the above described techniques exist in handling Arabic-like languages. Primarily, a high number of characters can be associated with one key. Upwards of five or more characters may be associated with one key. When the number of characters associated with a particular key increases, problems arise with both methods for entering text. In a multiple-stroke or manual method, the user may need to type twenty-five key stokes for a five letter word. Such a method is restrictive and time consuming. Additionally, editing is very difficult and slow.

In an automatic disambiguating system, a large number of matches may be generated through a small number of characters. This result leads to a decreasing probability of getting the desired word as the best match. Accordingly, much more time is used to get the desired match among all possible matches.

Arabic-like languages vary in the number of characters representing each alphabet. All of these languages have the same basic shape of characters, and differ only in the number and position of dots and marks around the characters.

In the illustrative embodiments, all dots and marks around each character are stripped away, leaving the base character naked. All different shapes of characters are mapped into a set of unique Basic Arabic Naked Characters (BANC) common to all the Arabic-like languages. This set can be used with a limited character keys keypad or with a limited layers keyboard common for all the Arabic-like languages.

There is accordingly provided a character formation method comprising the steps of specifying, in sequence, a selected plurality of basic Arabic naked characters, concatenating these basic Arabic naked characters to form a naked word comprising said basic Arabic naked characters, and transforming the naked word into a complete word on the basis of a predetermined language with which said naked word is associated. In an illustrative embodiment, the naked word consists solely of the basic Arabic naked characters.

This transformation of the naked word into a complete word may involve the modification of the naked word to replace basic Arabic naked characters with initial, medial, final, isolated or ligatured forms; to incorporate accents, vocalisation or diacritical marks; and generally to introduce the missing dots and marks around the characters. This task may be done with reference to a dictionary or language model data to identify one or more complete words corresponding to the naked word. The most probable complete word corresponding to the naked word thereby may be identified.

However, certain basic Arabic naked characters include a graphical element common to a plurality of different complete characters, and distinct from all other basic Arabic naked characters. For example, the basic Arabic naked character set may be derived from conventional Arabic characters having all diacritical marks removed. Still further, the basic Arabic naked characters may be drawn from the Arabic characters [symbol] (hamza), [symbol] (Hā′), [symbol] (dāl), [symbol] (rā′), [symbol] (s l̅n), [symbol] (Sād), [symbol] (Tā′), [symbol] (′ayn), [symbol] (lām), [symbol] (m l̅m), [symbol] (hā′), [symbol] (wāw), and the characters [symbol] (alif), [symbol] (bā′), [symbol] (qāf), [symbol] (kāf) and [symbol] (yā′) having all dots and marks removed. That is, seventeen characters.

In such devices, there may be a “setup” step where a user has to choose the language. In a setup step, there can be two options. The first option is to have each of the Arabic-like languages in the list of the language settings. In this case, each character set is loaded before usage. The second option is to have all Arabic-like languages as one choice among other languages. When chosen by the user, all possible character/dot combinations are loaded. When the user hits a character key with no dots or marks displayed around the characters, the user may optionally be given a list of possible “dots” and “marks” to add on top of the characters.

According to certain embodiments, a plurality of BANC's are assigned to some keys. For example in the case of a 3×4 keypad matrix, as on a mobile telephone handset or the like, it is necessary to assign two characters to some keys. Assigning multiple characters to a key means that keystrokes from these keys are ambiguous. As a result, a second level of ambiguity is introduced in the process of textual entry. First, there is an ambiguity on the BANC's level where it is needed to decide which BANC is meant by a keystroke. Second, there is an ambiguity on the Naked Arabic Word (NAW) level where it is needed to add dots and marks to generate the final meant Arabic word.

In general, the ambiguity can be resolved manually by the user, or automatically by the communication device itself. The keystroke sequence is processed by vocabulary modules, or Language Model, which match the sequence to corresponding stored words or other interpretations. A best matched word and/or word stem will be displayed to the user automatically after the user finishes typing word. When a displayed match is not the desired one, the user can see a list of all matches to select the desired word. Consolidating this number of different alphabets into one alphabet basic set provides a solution for different layouts of keyboards and keypads of these languages. One layout is ready to work with any language that only differs in the Language Model used while inputting the text.

The illustrative embodiments provide for a reduced number of character keys for Arabic-like languages. The illustrative embodiments may use word-level and context-level disambiguation to resolve ambiguities in keystrokes. In one embodiment, the system is implemented as a keypad of a cellular phone. Alternatively, the system can be constructed for any limited keys device, and the system can be implemented for limited layers keyboards.

In another illustrative example, a set of base characters is defined from the common base parts of the various characters used in the different Arabic like languages. Base characters are stripped of diacritical marks. A series of such basic Arabic naked characters is specified in sequence and then concatenated to form a naked word comprising said selected plurality of basic Arabic naked characters. In an illustrative embodiment, the naked word consists solely of the basic Arabic naked characters. This naked word is then transformed into a complete word on the basis of a predetermined language with which said naked word is associated. Transformation is accomplished by adding all necessary marks.

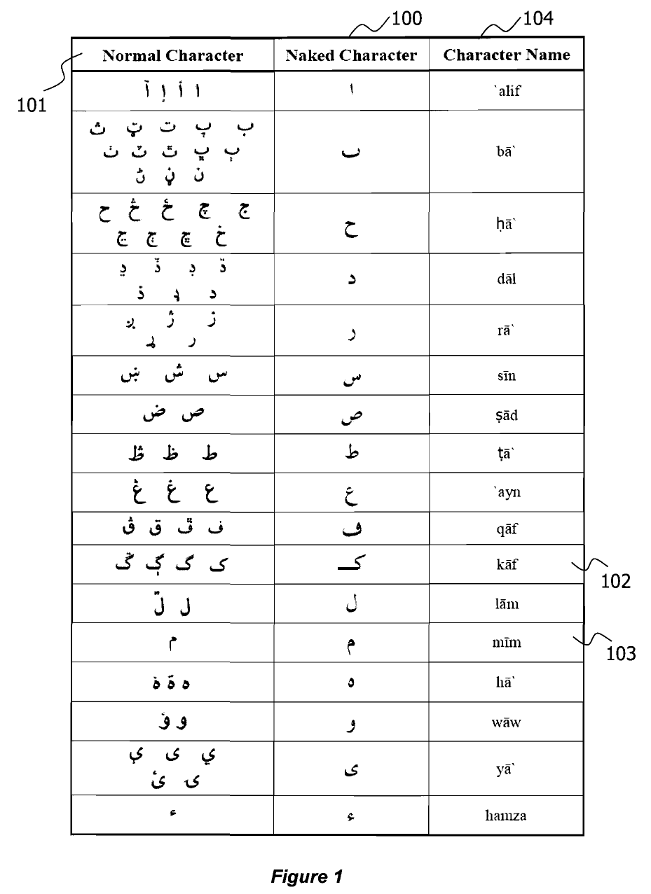

Turning now to the figures, FIG. 1 is a table of the mapping between the original characters of different languages and its Basic Arabic Naked Character (BANC), in accordance with an illustrative embodiment. FIG. 1 illustrates a table of a possible mapping between the original characters of different languages and the corresponding Basic Arabic Naked Characters. Column 100 presents different shapes of Arabic characters collected from different languages. Column 101 presents the BANC after stripping process. Column 104 presents the character name.

Some characters have only one version of its shape, such as column 102 for the Arabic language and column 103 for all Arabic-like languages. Some characters have more than one version. However there exist at most four different versions of a character for a given set of languages. Thus, Arabic-like languages may be provided without needing to substantially change the set of base characters.

As shown, the basic Arabic naked characters are drawn from the Arabic characters hamza, hā′, dāl, rā′, s l̅n, sād, tā′, ′ayn, lām, m l̅m, hā′, wāw, and the characters ‘alif, bā’, qāf, kāf and yā′ having all dots and marks removed. All characters from all desired Arabic-like languages are mapped onto one of these BANC, by removal of all marks and dots.

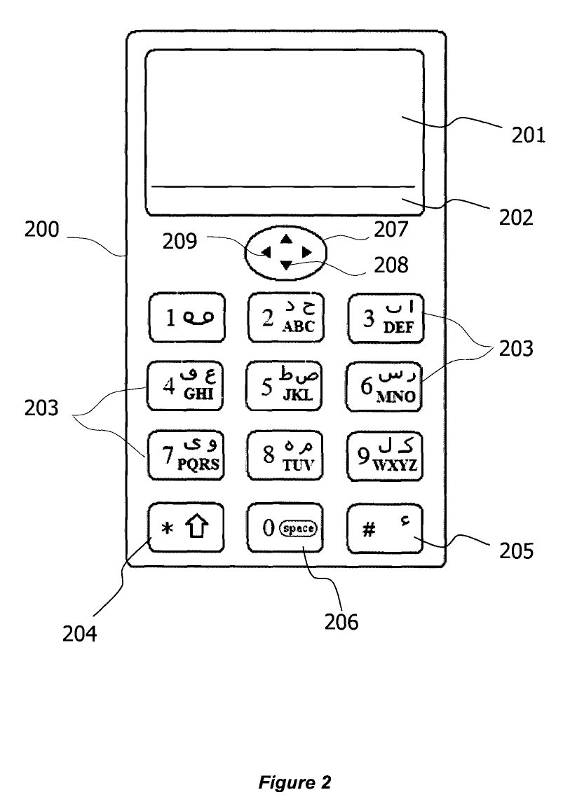

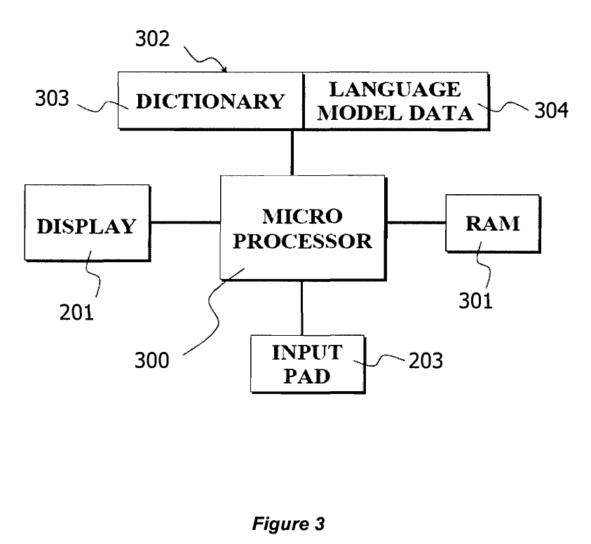

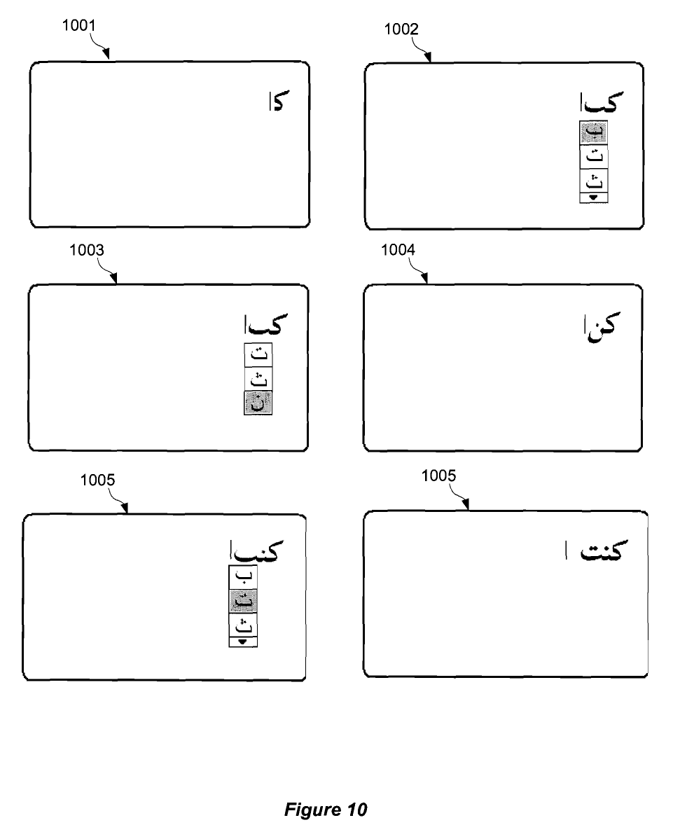

FIG. 2 shows a text entry device suitable to receive input, in accordance with an illustrative embodiment. FIG. 2 illustrates a first embodiment of an illustrative apparatus. FIG. 2 specifically shows an example of a cellular telephone. Cellular telephone 200 shown in FIG. 2 can be another data entry device, such as a wire line telephone, pager or personal digital assistant or telecommunications device having a keypad. Cellular telephone 200 comprises display 201 and keypad 203, through which input is received. Display 201 has a text display area and optional area 202 for displaying word, letter, combinations of words and letters, or character alternatives. Due to the technological evolution in cellular phones, area 202 will be displayed as a graphical list in the examples in FIG. 3 and FIG. 10.

Keypad 203 has twelve keys with digits 0-9 displayed thereon in a standard layout plus a function arrows key 207. Also, displayed in a standard layout are letters of the Roman alphabet A-Z and above them the BANC letters that are used to write Arabic-like text.

The BANC letters can be arranged in other arrangements but only 2 letters at most over a given key. The key bearing the digit “1” has the punctuation marks “-”, “?” and “*” displayed thereon. The key bearing the digit “2” has the roman letters ABC and the BANCS hā′ and dāl. The key bearing the digit “3” has the roman letters DEF and the BANCS corresponding to the linear part of the character ‘alif and the linear part of the character bā’. The key bearing the digit “4” has the roman letters GHI and the BANCS ayn and corresponding to the linear part of the character qāf. The key bearing the digit “5” has the roman letters JKL and the BANCS sād and tā′. The key bearing the digit “6” has the roman letters MNO and the rā′ and s l̅n characters. The key bearing the digit “7” has the roman letters PQRS and the BANCS wāw and corresponding to the linear part of the character ya. The key bearing the digit “8” has the roman letters TUV and the characters m l̅m and hā′. The key bearing the digit “9” has the roman letters WXYZ and the corresponding to the linear part of the character kāf and the character lām.

Lower left hand key 204 has the symbols [symbol] meaning “Shift” as is explained below, and *, referred to as “star”. Lower right hand key 205 has the symbols [symbol] meaning “Hamza” as is explained below, and “#”, referred to as “pound” or “hash”. Lower middle key 206, “0”, has the function of writing space in text mode.

Key 204 has the function of the shift key on normal keyboard. For English text, key 204 is used to write capital letters, but in Arabic-like languages, key 204 can be used to select between first and second letters associated to a key. Shift key 204 can be designed to be pressed while clicking a certain key like the case of keyboard, or it can be clicked once before clicking the needed key. The function arrow 207 is used to select between matched words generated by the disambiguating system as explained below.

Accordingly there is provided a keyboard comprising keys marked with basic Arabic naked characters. These basic Arabic naked characters are drawn from the Arabic characters hamza, hā′, dāl, rā′, s l̅n, sād, tā′, ‘ayn, lām, m l̅m, hā’, wāw, and the characters ‘alif, bā’, qāf, kāf and yā′ having all diacritical marks removed.

FIG. 3 is a block diagram detailing internal circuitry of the device of FIG. 2, in accordance with an illustrative embodiment. Cellular telephone 200 is illustrated as having microprocessor 300 coupled to the input pad 203 and to the display 201 using standard input and output drivers, as are known in the art. Also coupled to microprocessor 300 are first memory merchant 302, which is preferably electrically-erasable read-only memory (EEPROM), and second memory 301 which is preferably random access memory (RAM). In EEPROM memory 302 is stored dictionary 303. Dictionary 303 includes words and letter trigrams for the given Arabic-like language. Language model data 304 includes unigram weight values for the words and letter trigrams stored in the dictionary. Optionally data 304 also includes word bigram and even word trigram data. Other language model information can be stored with unigram weight values 304.

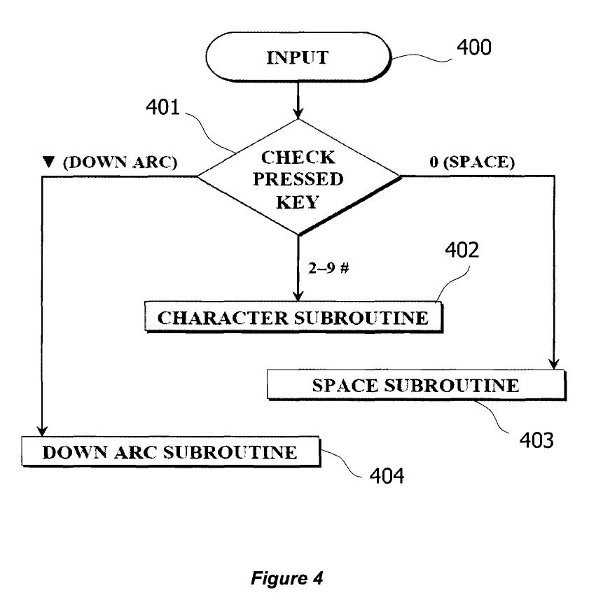

FIG. 4 is a flow diagram illustrating operation of the device of FIG. 2 in the automatic entry mode, in accordance with an illustrative embodiment. Referring to FIG. 4, a flow diagram indicates three different procedures for the system to carry out according to the input in case of the automatic mode. In the automatic mode, dots and marks are added to the BANC automatically. An input digit is received in step 400 by pressing briefly and releasing a certain key. Step 401 checks the kind of the pressed key. There are three types of keys. The first type of keys is keys have letters associated by them “2-9” and “#”. When one of these keys is pressed, subroutine 402 is executed and the needed BANC is displayed. The second type of keys is keys represented by key 206, “space” or “0” key. When pressed, subroutine 403 is executed and dots and marks are automatically added around the naked word. The space is then displayed. The third type of keys is represented by key 208, the “down arc” key. When pressed, subroutine 404 is executed and different matches for the input sequence of letters are displayed in display area 202, or displayed as a list.

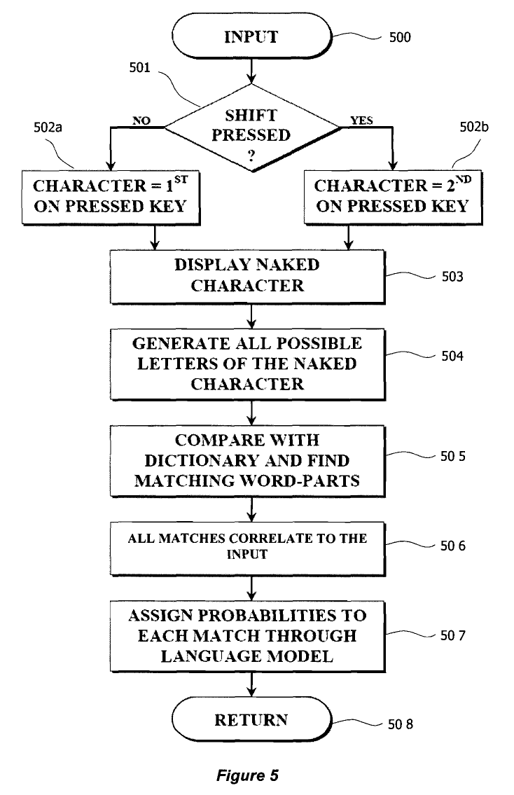

FIG. 5 through FIG. 7 show flow diagrams illustrating further details of the operation of FIG. 4, in accordance with illustrative embodiments. Referring now to FIG. 5, details of the subroutine 402 of FIG. 4 are shown. An input digit is received in step 500 (returns to input in step 400). Step 501 checks whether key 204 is pressed. Key 204 is assumed to be activated by press and hold, but it can be pressed once to toggle between shift states. The first or second character on the pressed key will be chosen and displayed naked from any dots or marks in steps 502a or 502b, respectively, and step 503. This process will be much less confusing for the user than displaying a wrong letter, as he can imagine the dots and marks in his mind easily.

In step 504 the BANC sequence entered so far is sent on to the next step for comparison against the contents of the dictionary 303. Thus, each entry is appended by microprocessor 300, as it is received, with previously entered BANC and the various possible corresponding letters being compared in step 505 with words from the dictionary 303. In step 506, all possible matches correlating to the input are identified and kept active for further steps in the process. In step 507, probabilities are assigned to the active matches using the unigram language modelling data 304. In step 508 the program returns to step 400 and awaits the next digit input.

An advantage of the illustrative embodiments is that the number of letters mapped to each BANC is much smaller than a key which is associated with four to five letters for the Arabic-like languages. In an illustrative embodiment, each BANC is mapped to one to four letters, with an average of two letters per BANC. Thus, the illustrative embodiments increase the speed of the data entry. Additionally, the illustrative embodiments allow for the usage of context language models with greater speed relative to prior systems, because the number of matched words in the illustrative embodiments is much smaller relative to prior systems.

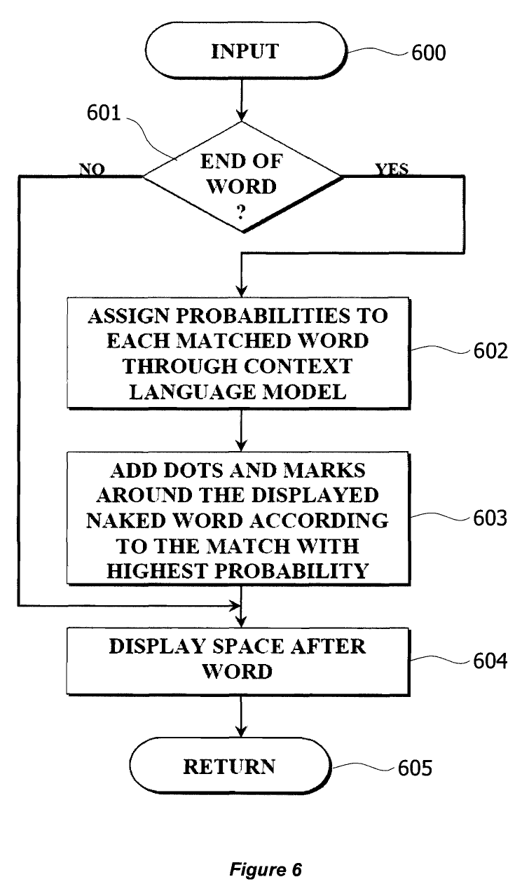

FIG. 6 is a flow diagram illustrating further details of the operation of the process shown in FIG. 4, in accordance with an illustrative embodiment; specifically, details regarding subroutine 403 are shown in FIG. 6. An input digit is received in step 600 (returns to input in step 400). Step 601 checks the previous displayed character. If the previous displayed character is a digit, symbol, or space, the subroutine jumps to step 604 and displays a space on the screen 201. However, if the previous character is a BANC, then an indication for word end is deduced and the subroutine goes to the next step.

In step 602, probabilities are assigned to the active matches using the context language model data and added to the calculated unigram probabilities calculated before. In Step 603, dots and marks are added to the naked word according to the active match with the highest probability. From that point, the subroutine goes to step 604 where a space is displayed after the displayed word. In step 605, the program returns to step 400 and awaits the next digit input. If the displayed match is not the intended match, the user can use the arrows key and return to the displayed word, then press key 208 to display different matches for the input sequence of BANCs.

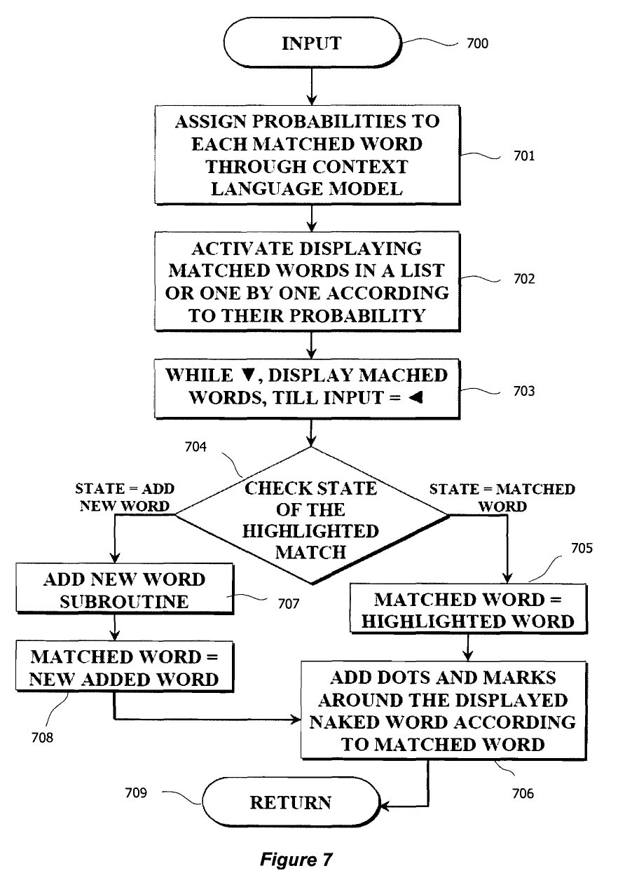

FIG. 7 is a flow diagram illustrating further details of the operation of the process shown in FIG. 4, in accordance with an illustrative embodiment; specifically, FIG. 7 shows the details of step 404 of FIG. 4. An input digit is received in step 700 (returns to input in step 400). Step 701 is the same of step 602, where probabilities are assigned to the active matches using the context language model. In step 702, matches are displayed on a list or on a display, such as display area 202 shown in FIG. 2.

In step 703, input is received from arrows key 207. In an illustrative embodiment, arrow 208 is used to scroll across the active matches and highlight one by one. The last choice in the list is “Add Word” when the intended match is not found among the active matches.

When the input changes from up/down arrows to left arrow key 209, step 704 is activated to check the last highlighted choice. If the highlighted choice is one of the active matches, then naked displayed word get dots and marks added to it according to the last highlighted word. However, if the choice is “Add Word”, then add new word subroutine 707 is executed to receive a new word from the user to be added to the dictionary. In this case, dots and marks are displayed around the naked word according to the new word in step 706. In step 709, the program returns to step 400 and awaits the next digit input.

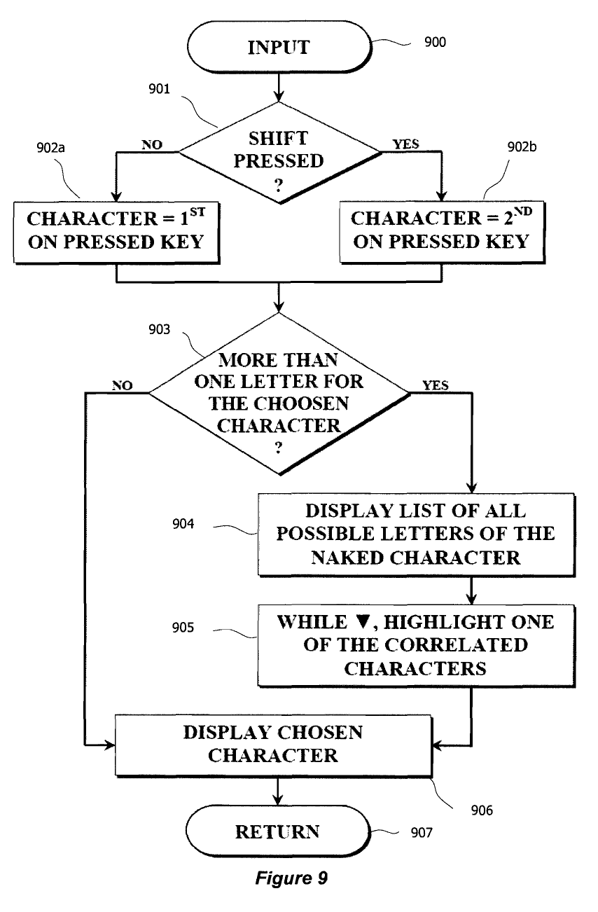

Skipping to FIG. 9, FIG. 9 is a flow diagram illustrating operation of the device of FIG. 2 in the manual entry mode, in accordance with an illustrative embodiment. This method is the manual method, where no dictionary or language models are used. In this method, input is received then checked while a shift key is pressed or not in steps 900, 901, 902a and 902b (the same as steps 500, 501, 502a and 502b respectively).

Step 903 checks if the input BANC has more than one letter mapped to it or no. If only one letter is mapped to it, the program jumps to step 906 and displays the character. Note that a number of letters mapped to each BANC differ from one language to another. If there is more than one character mapped to the input BANC, the process continues to step 904, where a list of all possible letters mapped to the given BANC is displayed in a list or in display area 202. In step 905, key 208, or any other function key or combination of multiply pressed keys, is used to scroll between possible letters. Possible letters are highlighted one by one. When key 209 is pressed, the highlighted letter is displayed in step 906. In step 907, the program returns to step 900 and awaits the next digit input.

### EXAMPLE 1

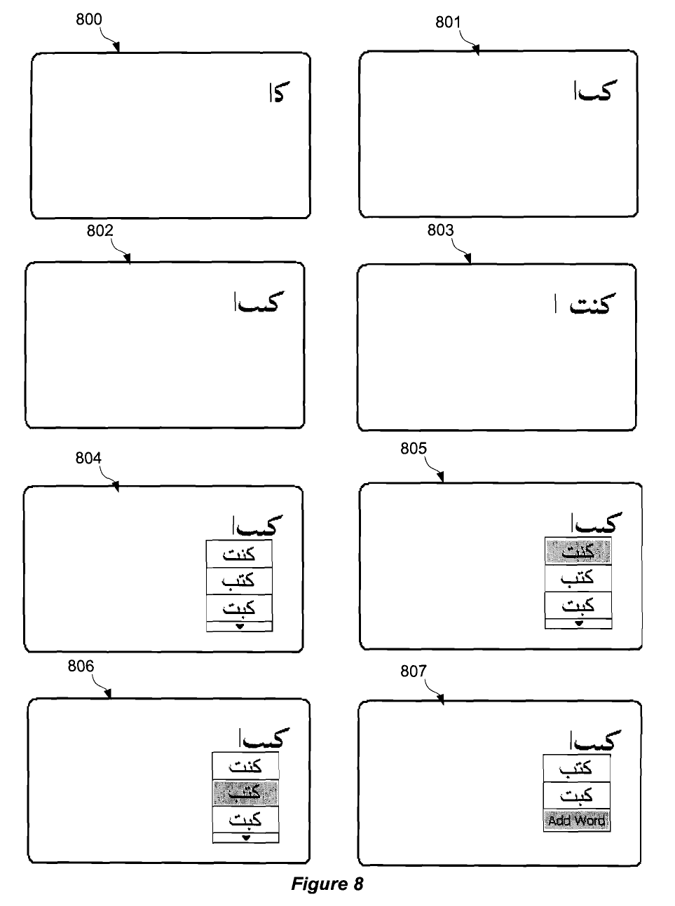

Referring back to FIG. 8, FIG. 8 is an illustrative example showing how dots and marks are automatically added when using the automatic entry mode, in accordance with an illustrative embodiment. Reference numerals 800, 801, and 802 represent the steps taken when writing an Arabic word. No dots or any marks are displayed around the characters. All that is displayed is the BANC's. Reference numeral 803 points to the displayed word after space is pressed, where the highest probability active match is displayed. Reference numeral 804 points to the displayed list when key 208 is pressed giving a list of all active matches. Reference numerals 805, 806, and 807 point to how the active matches are highlighted when scrolling through them. Reference numeral 807 points to an example where the last choice in the list is to add a new word that isn't found in the dictionary.

The input through cellular phone 200 to obtain output shown by reference numeral 803 is as follow:

9 shft+3 shft+3 space

The input through cellular phone 200 to obtain output shown by reference numeral 807 is as follow:

9 shft+3 shft+3 ▾ ▾ ▾

### EXAMPLE 2

FIG. 10 is an illustrative example of manual entry mode, in accordance with an illustrative embodiment. Reference numeral 1000 points to the displayed BANC with no list. In this example, the BANC returned by the selected key is the Arabic character [symbol] In Arabic, this character has only one letter mapped to it. However, if the selected language is Sindhi, a list of possible characters will appear, including “□”, “□”, “□”, and “□”. Reference numeral 1001 points to a naked character. Reference numeral 1002 points to a displayed list of possible letters that can be scrolled through using key 208. The displayed list is based on the naked character. Reference numeral 1003 shows the displayed letter after choosing it using key 209. Other displayed letters are shown at reference numerals 1004 and 1005. Reference numeral 1005 points to the finally selected character.

The input through the cellular phone 200 to obtain output shown in 1005 is as follow:

9 shft+3 ▾ ▾ ▾ [symbol] shft+3 ▾ [symbol] space

According to a further embodiment, a set of base characters is defined derived from the common base parts of the various characters used in the different Arabic-like languages, stripped of diacritical marks etc. A series of such basic Arabic naked characters is specified in sequence. The series is then concatenated to form a naked word comprising said selected plurality of basic Arabic naked characters. This naked word is then transformed into a complete word on the basis of a predetermined language with which said naked word is associated by adding all necessary marks.

The invention can take the form of an entirely hardware embodiment, an entirely software embodiment or an embodiment containing both hardware and software elements. In a preferred embodiment, the invention is implemented in software, which includes but is not limited to firmware, resident software, microcode, etc.

Furthermore, the invention can take the form of a computer program product accessible from a computer-usable or computer-readable medium providing program code for use by or in connection with a computer or any instruction execution system. For the purposes of this description, a computer-usable or computer readable medium can be any tangible apparatus that can contain, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A computer-implemented method of word formation in a data processing system, the computer-implemented method comprising:
receiving, in sequence, a plurality of basic Arabic naked characters;
concatenating the plurality of basic Arabic naked characters to form a naked word comprising solely the plurality of basic Arabic naked characters;
associating the naked word with a first Arabic-like language;
transforming the naked word into a complete word in the first Arabic-like language; and
displaying the complete word.

2. The computer-implemented method of claim 1 wherein transforming the naked word into a complete word comprises modifying the naked word to incorporate at least one of an initial, medial, final, isolated, or ligatured form.

3. The computer-implemented method of claim 1 wherein transforming the naked word into a complete word comprises modifying the naked word to incorporate at least one of a vocalization or a diacritical mark.

4. The computer-implemented method of claim 2 wherein transforming the naked word into a complete word comprises transforming with reference to at least one of a dictionary or language model data to identify at least one candidate complete word corresponding to the naked word.

5. The computer-implemented method of claim 4 wherein the reference to at least one of a dictionary or language model data is used to identify a most probable complete word corresponding to the naked word.

6. The computer-implemented method of claim 1 further comprising:
prior to receiving the plurality of basic Arabic naked characters, receiving a sequence of user inputs, wherein at least one user input in the sequence corresponds to a preliminary plurality of basic naked characters.

7. The computer-implemented method of claim 6 wherein one of the preliminary plurality of basic Arabic naked characters is automatically selected for inclusion in the naked word by reference to at least one of a dictionary or language model data.

8. The computer-implemented method of claim 1 wherein the plurality of basic Arabic naked characters include at least one graphical element common to a plurality of different complete characters, but distinct from all other basic Arabic naked characters.

9. The computer-implemented method of claim 1 wherein the plurality of basic Arabic naked characters are derived from conventional Arabic characters having all diacritical marks removed.

10. The computer-implemented method of claim 9 wherein the plurality of basic Arabic naked characters are selected from the group of Arabic characters consisting of: hamza, hā′, dāl, rā′, s l̅n, sād, tā′, ′ayn, lām, m l̅m, hā′, wāw, ‘alif, bā′, qāf, kāf, and yā′, and wherein each Arabic character in the group has all diacritical marks removed.

11. A keyboard comprising keys marked with basic Arabic naked characters selected from the group consisting of: hamza, hā′, dāl, rā′, s l̅n, sād, tā′, ‘ayn, lā, m l̅m, hā′, wāw, ‘alif, bā’, qāf, kāf and yā′, wherein each Arabic character in the group has all diacritical marks removed.

12. A computer-readable medium containing a computer program product for word formation in a data processing system, the computer program product comprising:
instructions for receiving, in sequence, a plurality of basic Arabic naked characters;
instructions for concatenating the plurality of basic Arabic naked characters to form a naked word comprising solely the plurality of basic Arabic naked characters;
instructions for associating the naked word with a first Arabic-like language; and
instructions for transforming the naked word into a complete word in the first Arabic-like language.

13. The computer-readable medium of claim 12 wherein the instructions for transforming the naked word into a complete word comprises instructions for modifying the naked word to incorporate at least one of an initial, medial, final, isolated, or ligatured form.

14. The computer-readable medium of claim 12 wherein the instructions for transforming the naked word into a complete word comprise instructions for modifying the naked word to incorporate at least one of a vocalization or a diacritical mark.

15. The computer-readable medium of claim 13 wherein the instructions for transforming the naked word into a complete word comprises instructions for transforming with reference to at least one of a dictionary or language model data to identify at least one candidate complete word corresponding to the naked word.

16. The computer-readable medium of claim 15 wherein the reference to at least one of a dictionary or language model data is used to identify a most probable complete word corresponding to the naked word.

17. The computer-readable medium of claim 12 further comprising:
instructions for, prior to receiving the plurality of basic Arabic naked characters, receiving a sequence of user inputs, wherein at least one user input in the sequence corresponds to a preliminary plurality of basic naked characters.

18. The computer-readable medium of claim 17 wherein one of the preliminary plurality of basic Arabic naked characters is automatically selected for inclusion in the naked word by reference to at least one of a dictionary or language model data.

19. The computer-readable medium of claim 12 wherein the plurality of basic Arabic naked characters include at least one graphical element common to a plurality of different complete characters, but distinct from all other basic Arabic naked characters.

20. The computer-readable medium of claim 12 wherein the plurality of basic Arabic naked characters are derived from conventional Arabic characters having all diacritical marks removed.
